(19) United States
(12) Patent Application Publication
(10) Pub. No.: US 2018/0140492 A1
(43) Pub. Date: May 24, 2018

(54) HEALTH-CARE DEVICE

(71) Applicant: En-Chiuan LIOU, Tainan City (TW)

(72) Inventor: En-Chiuan LIOU, Tainan City (TW)

(21) Appl. No.: 15/821,453

(22) Filed: Nov. 22, 2017

(30) Foreign Application Priority Data
Nov. 24, 2016 (TW) 105138668
Nov. 24, 2016 (TW) 105217980
Apr. 28, 2017 (TW) 106114270

(51) Int. Cl. A61G 7/057; A61G 7/10; A61G 7/05

(52) U.S. Cl. CPC A61G 7/05784; A61G 7/1021; A61G 7/1015; A61G 7/1019; A61G 2203/46; A61G 7/0516; A61G 2203/10; A61G 2203/34; A61G 7/0524

(57) ABSTRACT

A health-care device for supporting a human body rested on a carrier includes an air-permeable member, a moving unit, an air regulating unit and a control unit. The air-permeable member is connected with the carrier and under the human body. A moving unit is operative to move the carrier or the air-permeable member to generate an airflow space between the carrier and the human body. An air regulating unit is operative to permit air flowing through the airflow space to reduce the discomfort feeling of the bedridden patient. The control unit is connected to control the air regulating unit and the moving unit.

### CROSS-REFERENCE TO RELATED APPLICATION

This application claims priority of Taiwanese Patent Application No. 105138668, filed on Nov. 24, 2016, Taiwanese Patent Application No. 105217980, filed on Nov. 24, 2016, and Taiwanese Patent Application No. 106114270, filed on Apr. 28, 2017.

### FIELD

The disclosure relates to a health-care device, and more particularly to a health-care device with an air regulating function for preventing bedsores in long-term care patient.

### BACKGROUND

Bedsores, also known as pressure ulcers, are a common problem encountered by long-term medical care patients, such as those being bedridden or confined to a wheelchair.

Bedsores occur due to a pressure in individuals who are not moving about and applied to soft tissue resulting in completely or partially obstructed blood flow to the soft tissue. Thus, to prevent or decrease development of bedsores, nutrition therapy to enhance immunity, an external physical care system and method is required to turn patients over to keep them from prolonged pressure. Skin injury should be avoided during turning over. Moreover, a carrier, such as a bed or a wheelchair on that a patient is rested, should be kept from moisture. Hence, it is desired to develop a health-care method and system for preventing or decreasing bedsores.

### SUMMARY

Therefore, an object of the disclosure is to provide a health-care device that can alleviate at least one of the drawbacks of the prior art.

According to the disclosure, the health-care device for supporting a human body rested on an upper major surface of a carrier includes an air-permeable member, a moving unit, an air regulating unit and a control unit. The air-permeable member is configured to be connected with the carrier and under the human body. The moving unit is disposed on the carrier, and is operative to move one of the carrier and the air-permeable member relative to the other one of the carrier and the air-permeable member so as to generate an airflow space between the carrier and the human body. The air regulating unit is mounted adjacent to one side of the upper major surface of the carrier, and is operative to permit air flowing through the airflow space. The control unit is connected to at least one of the air regulating unit and the moving unit.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating a first embodiment of a health-care device according to the disclosure;

FIG. 2 is a partly-sectional side view of the first embodiment;

FIG. 3 is a perspective view illustrating a moving unit of the first embodiment with a modified form;

FIG. 4 is a fragmentary, partly-sectional side view illustrating the first embodiment in a state when an airflow space is formed;

FIGS. 5 to 7 are fragmentary, partly-sectional side views each illustrating the moving unit of the first embodiment with another modified form;

FIG. 8 is a partly-sectional side view illustrating the moving unit of the first embodiment with a still another modified form;

FIG. 9 is a perspective view illustrating a second embodiment of a health-care device according to the disclosure;

FIG. 10 is a block diagram of the second embodiment;

FIG. 11 is a perspective view illustrating a third embodiment of a health-care device according to the disclosure; and

FIG. 12 is a perspective view illustrating an air regulating unit of the third embodiment with a modified form.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

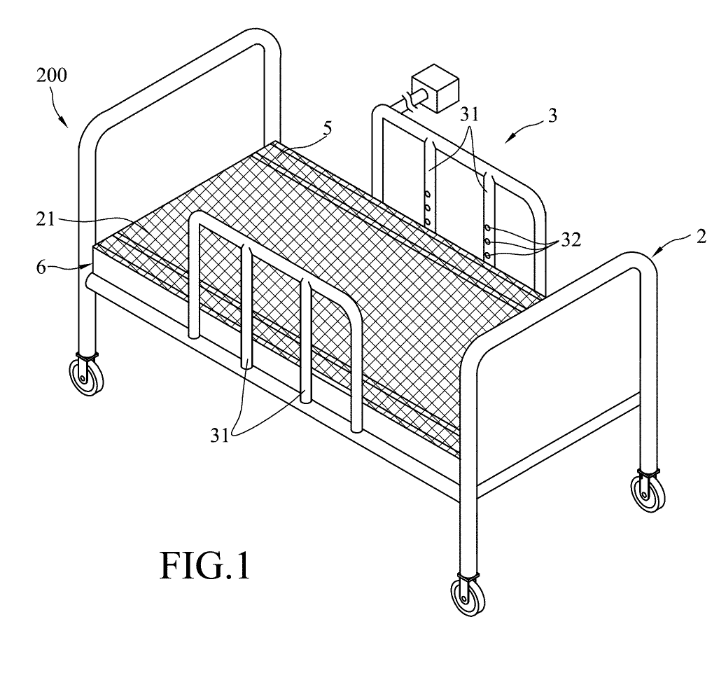

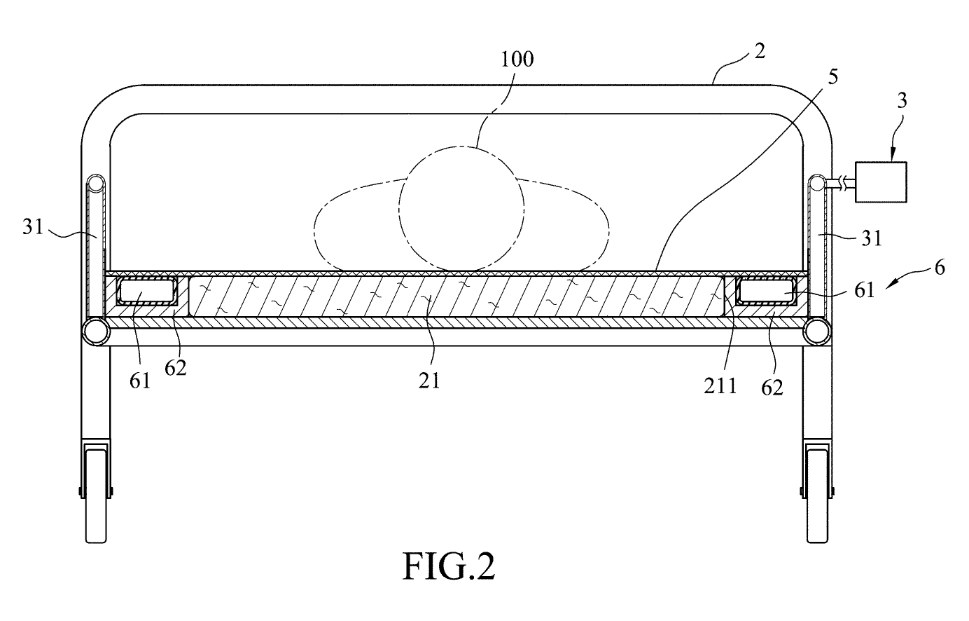

Referring to FIGS. 1 to 4, a first embodiment of a health-care device 200 is adapted to be used with a support seat 2 for caring a human body 100 rested on an upper major surface of a carrier 21 of the support seat 2. The support seat 2 may be a wheelchair, a bed frame or a hospital bed, and the carrier 21 may be a seat on the wheelchair, or a bed mattress or a bed plate on the bed frame or the hospital bed. In this embodiment, the support seat 2 is a hospital bed as an example.

The health-care device 200 includes an air regulating unit 3, an air-permeable member 5 and a moving unit 6.

The air regulating unit 3 has at least one air pipe 31 which is detachably fastened to the support seat 2 by means of a clamp or a screw fastener, which is mounted adjacent to at least one side of the upper major surface of the carrier 21, and which has at least one penetrating hole 32. As the carrier 21 is a mattress of a single hospital bed for example, the upper major surface of the carrier 21 may have two long sides 211. The air pipe 31 may be disposed at each long side 211 of the carrier 21. FIG. 1 illustrates the embodiment wherein two of the air pipes 31 are disposed at each long side 211 of the carrier 21 and communicated with each other. Each of the air pipes 31 has a plurality of penetrating holes 32 penetrating toward the upper major surface of the carrier 21. Moreover, the air pipe 31 may be fastened to the support seat 2 in soldering or other manner and is not detached therefrom.

The air regulating unit 3 can supply air with predetermined humidity and temperature to the air pipes 31.

The air-permeable member 5 is made of an air-permeable material, and configured to be connected with the carrier 21 in a tensed state and upon the upper major surface of the carrier 21 for supporting or lifting a human body 100.

As a soft and warm sheet (not shown), such as a cushion or a blanket, is placed on the carrier 21, the air-permeable member 5 is placed on the upper surface thereof to directly contact the human body 100.

Specifically, the air-permeable member 5 may have a porous or fabric structure to be air-permeable. The air-permeable member 5 must have a sufficient tension to support the human body 100 rested thereon when the human body 100 is moved away from the carrier 21. In this embodiment, the air-permeable member 5 is an air-permeable mesh fabric.

The moving unit 6 is disposed on the carrier 21, and is operative to move one of the carrier 21 and the air-permeable member 5 relative to the other one of the carrier 21 and the air-permeable member 5 so as to generate an airflow space 101 between the upper major surface of the carrier 21 and the human body 100 supported by the air-permeable member 5. The air-permeable member 5 is kept in the tensed state during this movement. Specifically, the moving unit 6 is operative to lift one side of the air-permeable member 5 or the entire air-permeable member 5 to make inclination of the air-permeable member 5 or raise the air-permeable member 5 away from the carrier 21. Alternatively, the moving unit 6 is operative to lower one side of the carrier 21 or the entire carrier 21 away from the air-permeable member 5 so as to form the airflow space 101 between the human body 100 and the carrier 21.

As the moving unit 6 is operative to lift the air-permeable member 5, the moving unit 6 has a lifting member 61 which is connected with the air-permeable member 5 and which is operative to lift the air-permeable member 5 away from the upper major surface of the carrier 21 to generate the airflow space 101 and to keep the air-permeable member 5 in the tensed state. The lifting member 61 may be one of an air bladder, a roller, a cord and a lifting frame, each of which is connected to a periphery of the air-permeable member 5.

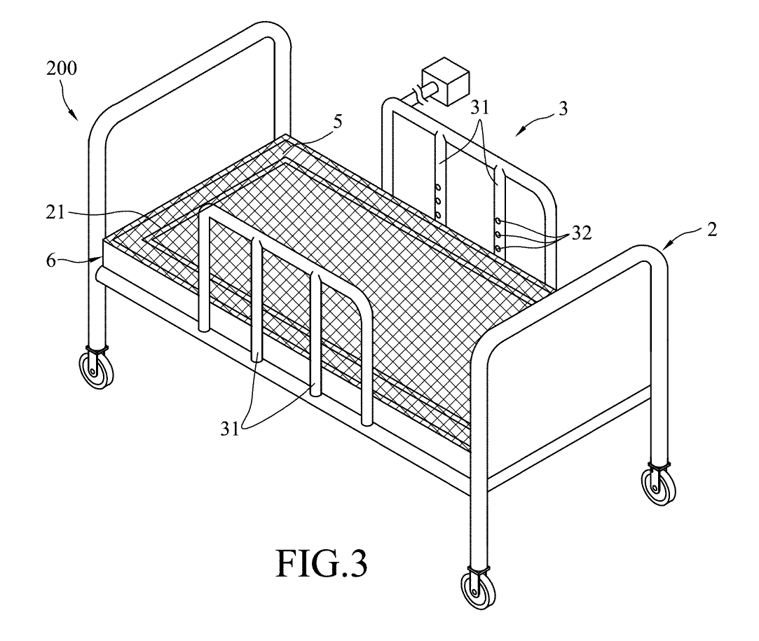

Specifically, the moving unit 6 has an inflatable air bladder 61 which is disposed below and connected to the periphery of the air-permeable member 5 to serve as the lifting member, a frame 62 which is disposed for accommodating the air bladder 61, and a motor (not shown) which is disposed to inflate the air bladder 61 so as to lift the air-permeable member 5. In FIG. 1, the air bladder 61 and the frame 62 are disposed at two long sides of the upper major surface of the carrier 21. Alternatively, in FIG. 3, the air bladder 61 and the frame 62 are disposed to surround the periphery of the carrier 21 to enhance the support to the air-permeable member 5. In addition, the power supply of the motor can be selected from a battery, a plug-in electric power and UPS (Uninterruptible Power Supply). Moreover, a relief valve (not shown) may be connected with the air bladder 61 to control the air amount therein so as to adjust the lifting of the air-permeable member 5 (for example, lifting of one side or two sides of the air-permeable member 5).

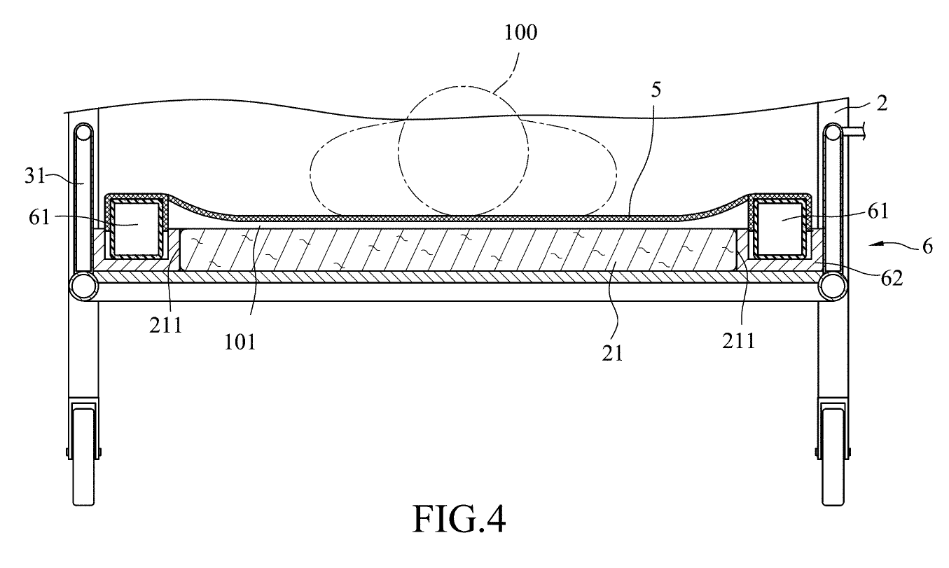

Once the air bladder 61 is inflated, the air-permeable member 5 can be lifted away from the carrier 21 so as to move the human body 100 rested on the air-permeable member 5 away from the carrier 21 to reduce the pressure upon the local tissue of the human body 100, and to generate the airflow space 101. In this state, the air regulating unit 3 can be operative to supply air through the air pipe 31 and permit air flowing through the airflow space 101 so as to regulate the temperature and/or humidity at the contact surface of the human body 100. FIG. 4 illustrates the state where the air bladder 61 is inflated and the air-permeable member 5 is lifted.

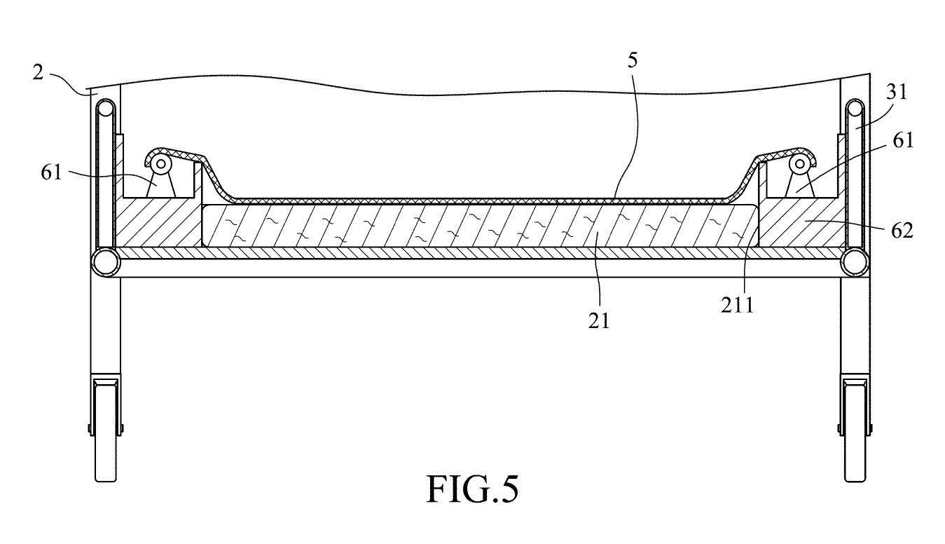

With reference to FIG. 5, the moving unit 6 has two rollers 61 to serve as the lifting member, a frame 62 disposed for accommodating the rollers 61, and a motor (not shown) disposed to drive rolling of the rollers 61. The rollers 61 are connected to two opposite sides of the air-permeable member 5 to roll and lift the air-permeable member 5 in a tensed state.

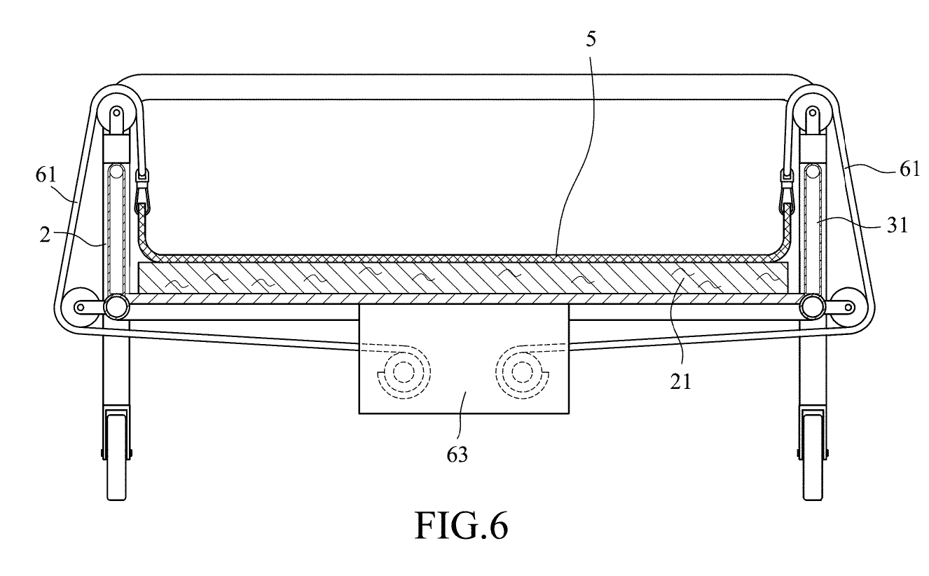

With reference to FIG. 6, the moving unit 6 has two cords 61 respectively connected to two opposite sides of the air-permeable member 5 to serve as the lifting member, a reel 63 disposed to reel the cords 61, and a motor (not shown) disposed to drive the reel 63 to reel the cords 61 so as to lift the air-permeable member 5 away from the carrier 21.

The above-mentioned lifting member 61 (air bladder, roller, cord) can be controlled to lift one side or both sides of the air-permeable member to adjust the contact position of the human body 100 with the carrier 21. Moreover, an extra air pipe 31 can be disposed on the support seat 2 at a region where the carrier 21 is not mounted so as to increase airflow around the carrier 21.

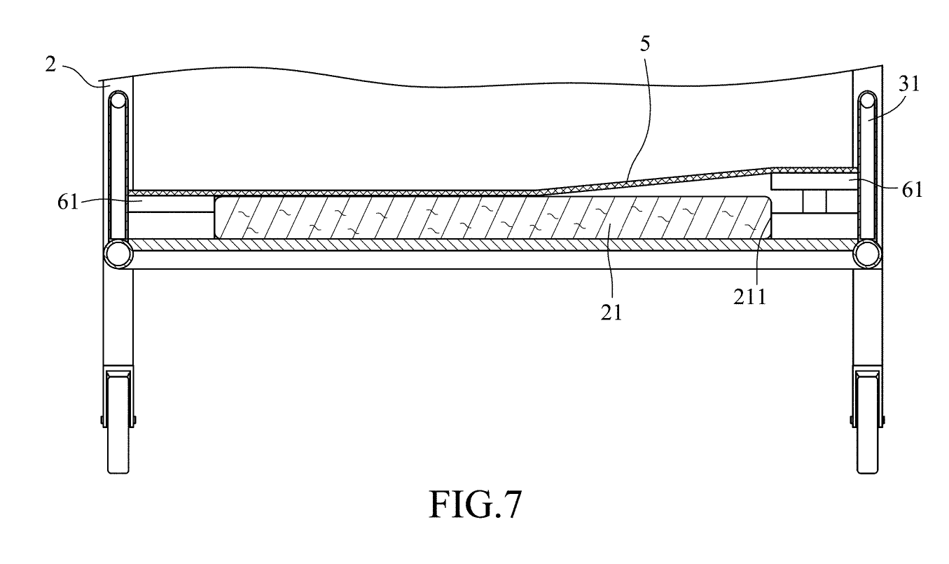

With reference to FIG. 7, the moving unit 6 has a lifting frame 61 which is connected with and surrounds the periphery of the air-permeable member 5 and which is operative to move in an upper-and-lower direction to move the air-permeable member 5 in the upper-and-lower direction. The lifting frame 61 can be controlled to move a single side of the air-permeable member 5, as shown in FIG. 7, or the entire air-permeable member 5.

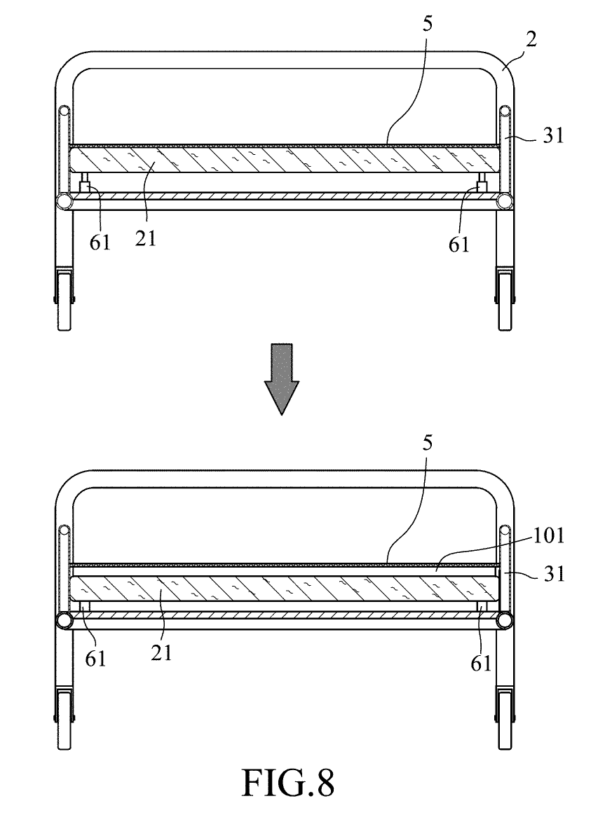

With reference to FIG. 8, the moving unit 6 is operative to lower the carrier 21, and has a plurality of pneumatic/hydraulic cylinders 61 disposed below the carrier 21 to be driven to lower the carrier 21 relative to the air-permeable member 5. Meanwhile, the air-permeable member 5 is secured to the support seat 2 with a sufficient tension to support the human body. Hence, the airflow space 101 is generated between the human body 100 and the carrier 21.

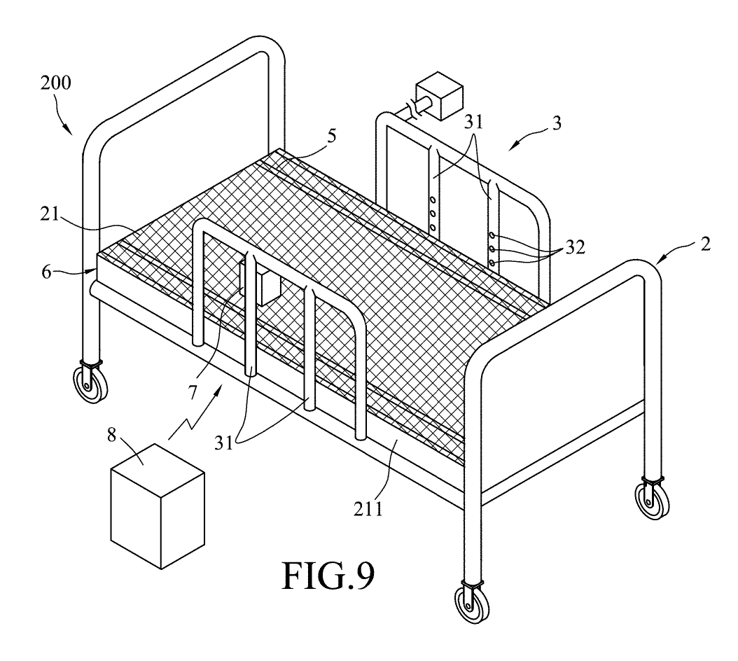

Referring to FIG. 9, in a second embodiment, the health-care device 200 further includes a detecting unit 7 and an automatic control unit 8.

The detecting unit 7 is in signal connection with at least one of the air regulating unit 3 and the moving unit 6 in a wire or wireless connecting manner, and is disposed adjacent to or on the contact area between the human body 100 and the carrier 21.

The detecting unit 7 detects at least one of physiological signals that are generated from the human body 100 and the surrounding environment thereof. The physiological signals may be sound, temperature, moisture of the surrounding environment, and heart rate, pulse rate, blood pressure, body temperature, respiration rate and breathing vibration of the human body 100. The detecting unit 7 may also include a pressure sensor to detect the pressure change during movement of the human body 100. For example, the temperature/humidity increments of the back of the human body 100, the respiration or heart rate change of the human body 100, and the pressure on the local tissue of the human body 100 can be measured by the detecting unit 7. The air regulating unit 3 and/or the moving unit 6 can be controlled in accordance with the measured result from the detecting unit 7 to perform air supplying work and/or moving work.

The automatic control unit 8 is in signal connection with at least one of the air regulating unit 3 and the moving unit 6 in a wire or wireless connecting manner, and is programmable to control the operation of at least one of the air regulating unit 3 and the moving unit 6. Specifically, the automatic control unit 8 may be programmed to periodically actuate the operation of at least one of the air regulating unit 3 and the moving unit 6 without the detecting unit 7. Alternatively, the automatic control unit 8 may be in signal connection with the detecting unit 7 and receives a signal from the detecting unit 7 to programmably control the operation of at least one of the air regulating unit 3 and the moving unit 6.

For example, with the control of the automatic control unit 8, the moving unit 6 can be periodically actuated to lift the air-permeable member 5. Alternatively, by combination with the detecting unit 7, once the detecting unit 7 measures a value of temperature/humidity out of a predetermined range, or a value of pressure unchanged for a predetermined time period, a signal is generated and submitted to the automatic control unit 8. The automatic control unit 8 actuates the moving unit 6 to move the air-permeable member 5 or the carrier 21, and/or the air regulating unit 3 to supply air through the airflow space 101. Thus, the consistent pressure applied to a specific part of the human body 100 can be prevented, and the temperature/humidity thereof can be regulated.

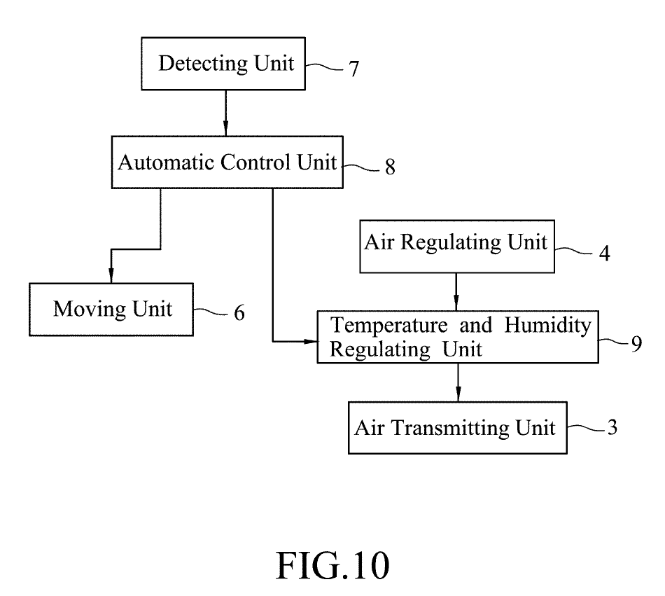

Moreover, as shown in FIG. 10, the health-care device 200 further includes a temperature and humidity regulating unit 9 to regulate temperature and humidity of the air supplied by the air regulating unit 3. The temperature and humidity regulating unit 9 can be operative individually, or is in signal connection with the detecting unit 7 and/or the automatic control unit 8 so as to be actuated by the detecting unit 7 and/or the automatic control unit 8.

For example, in FIG. 10, the detecting unit 7 is in signal connection with the automatic control unit 8. The automatic control unit 8 is in signal connection with both the air regulating unit 3 and the moving unit 6. Thus, when the automatic control unit 8 receives a signal from the detecting unit 7 and controls the movement of the moving unit 6 and the operation of the temperature and humidity regulating unit 9 in accordance with the signal so as to regulate the temperature and humidity of the air supplied to the air pipes 31.

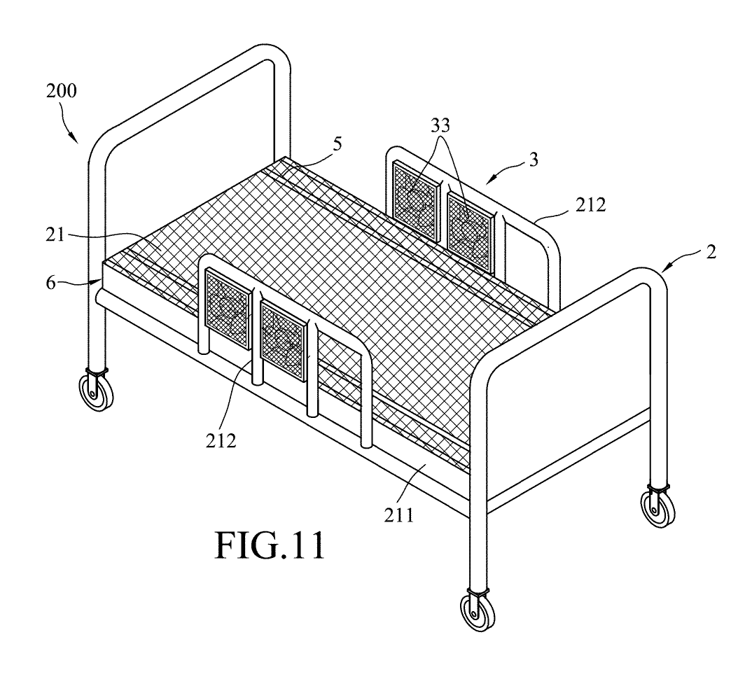

Referring to FIG. 11, in a third embodiment, the air regulating unit 3 is disposed to supply air through the airflow space 101 without the air pipe. Specifically, the air regulating unit 3 has at least one air supplying member 33 disposed at one long side 211 of the upper major surface of the carrier 21. The air supplying member 33 may be a common electric fan or a fan with temperature/humidity regulating function. In FIG. 11, a plurality of the air supplying members 33 are disposed and each is controlled individually for the amount of airflow, the humidity and/or temperature. Moreover, the air supplied by the air regulating unit 3 may be selected from air and a combination of air and at least one of water, anti-inflammatory medicament and sterilization medicament.

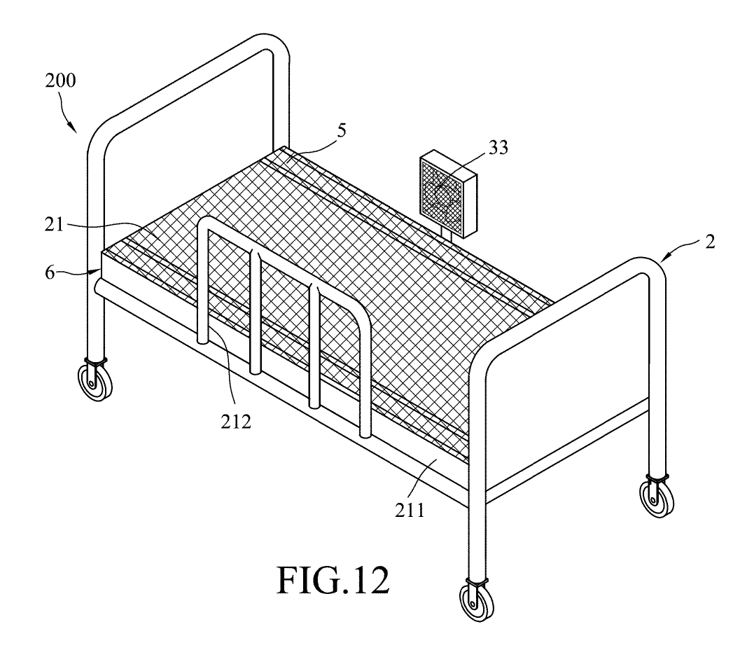

In the embodiment shown in FIG. 11, a guard fence 212 is movably disposed on the support seat 2 at each long side 211 of the carrier 21 and extends upwardly from the long side 211. The guard fence 212 defines three accommodating spaces. The air supplying members 33 are mounted on the guard fences 211 and which are accommodated in the accommodating spaces to be registered with the airflow space 101. Alternatively, in FIG. 12, a guard fence 212 and an air supplying member 33 are respectively disposed at two opposite long sides 211 of the carrier 21. The air supplying member 33 is movably or rotatably disposed on the support seat 2 in a lengthwise direction of the long side 211 and/or a transverse direction that is transverse to the lengthwise direction by means of a guide rail (not shown) or a rotating member (not shown) so as to adjust the position thereof relative to the air-permeable member 5.

Moreover, in the third embodiment, the air regulating unit 3 and the moving unit 6 can be in signal connection with the detecting unit 7 and/or the automatic control unit 8 as described above in the previous embodiment, so as to facilitate operation of the health-care device 200.

As illustrated, with the moving unit 6 and the air-permeable member 5, a human body 100 is supported by the air-permeable member 5, and an airflow space 101 is generated between the human body 100 and the carrier 21. With the air regulating unit 3 to supply airflow through the airflow space 101, the humidity and temperature at the contact area of the human body 100 with the carrier 21 can be regulated to reduce the discomfort feeling of the bedridden patient. Further with the detecting unit 7, the automatic control unit 8 and the temperature and humidity regulating unit 9, the operation of the moving unit 6 and the air regulating unit 3 can be programmed and controlled in accordance with the signal detected by the detecting unit 7 to the human body 100 and the surrounding environment.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A health-care device for supporting a human body rested on an upper major surface of a carrier, comprising:
an air-permeable member configured to be connected with the carrier and under the human body;
a moving unit disposed on the carrier, and operative to move one of the carrier and said air-permeable member relative to the other one of the carrier and said air-permeable member so as to generate an airflow space between the carrier and the human body;
an air regulating unit mounted adjacent to one side of the upper major surface of the carrier and operative to permit air flowing through said airflow space; and
a control unit connected to at least one of said air regulating unit and said moving unit.

2. The health-care device as claimed in claim 1, wherein said air regulating unit has at least one air pipe that has at least one penetrating hole such that said air regulating unit supplies air to said airflow space through said air pipe.

3. The health-care device as claimed in claim 1, wherein said air supplied by said air regulating unit is selected from air and a combination of air and group A, wherein the group A includes water, anti-inflammatory medicament and sterilization medicament.

4. The health-care device as claimed in claim 1, wherein said moving unit has a lifting member which is connected with said air-permeable member and which is operative to lift said air-permeable member away from the carrier to generate said airflow space.

5. The health-care device as claimed in claim 4, wherein said lifting member is one of an air bladder, a roller, a cord and a lifting frame, each of which is connected to said air-permeable member.

6. The health-care device as claimed in claim 1, further comprising a detecting unit which is in signal connection with at least one of said air regulating unit and said moving unit to detect at least one of physiological signals that are generated from the human body and the surrounding environment and that are sound, temperature, moisture of the surrounding environment, and heart rate, pulse rate, blood pressure, body temperature, respiration rate and breathing vibration of the human body.

7. The health-care device as claimed in claim 1, wherein said control unit is in signal connection with at least one of said air regulating unit and said moving unit, and is programmable to control the operation of said at least one of said air regulating unit and said moving unit.

8. The health-care device as claimed in claim 6, wherein said control unit is in signal connection with said detecting unit and receives a signal from said detecting unit to programmably control the operation of said at least one of said air regulating unit and said moving unit.

9. The health-care device as claimed in claim 8, further comprising a temperature and humidity regulating unit which is in signal connection with said control unit to be controlled by said control unit in accordance with the signal received from said detecting unit to regulate the temperature and humidity of the air supplied by said air regulating unit.

10. The health-care device as claimed in claim 1, further comprising a temperature and humidity regulating unit which is operative to regulate the temperature and humidity of the air supplied by said air regulating unit.

11. A health-care device comprising:
a carrier having an upper major surface for a human body rested thereon;
an air-permeable member configured to be connected with said carrier and under the human body;
a moving unit disposed on said carrier, and operative to move one of said carrier and said air-permeable member relative to the other one of said carrier and said flexible member so as to generate an airflow space between said carrier and the human body;
an air regulating unit mounted adjacent to one side of the upper major surface of the carrier and operative to permit air flowing through said airflow space; and
a control unit connected to at least one of said air regulating unit and said moving unit.

12. The health-care device as claimed in claim 11, wherein said air regulating unit has at least one air pipe that has at least one penetrating hole such that said air regulating unit supplies air to said airflow space through said air pipe.

13. The health-care device as claimed in claim 11, wherein said air supplied by said air regulating unit is selected from air and a combination of air and group A, wherein the group A includes water, anti-inflammatory medicament and sterilization medicament.

14. The health-care device as claimed in claim 11, wherein said moving unit has a lifting member which is connected with said air-permeable member and which is operative to lift said air-permeable member away from said carrier to generate said airflow space.

15. The health-care device as claimed in claim 14, wherein said lifting member is one of an air bladder, a roller, a cord and a lifting frame, each of which is connected to a periphery of said air-permeable member.

16. The health-care device as claimed in claim 11, further comprising a detecting unit which is in signal connection with at least one of said air regulating unit and said moving unit to detect at least one of physiological signals that are generated from the human body and the surrounding environment and that are sound, temperature, moisture of the surrounding environment, and heart rate, pulse rate, blood pressure, body temperature, respiration rate and breathing vibration of the human body.

17. The health-care device as claimed in claim 11, wherein said control unit is in signal connection with at least one of said air regulating unit and said moving unit and which is programmable to control the operation of said at least one of said air regulating unit and said moving unit.

18. The health-care device as claimed in claim 16, wherein said control unit is in signal connection with said detecting unit and at least one of said air regulating unit and said moving unit, and receives a signal from said detecting unit to programmably control the operation of said at least one of said air regulating unit and said moving unit.

19. The health-care device as claimed in claim 18, further comprising a temperature and humidity regulating unit which is in signal connection with said control unit to be controlled by said control unit in accordance with the signal received from said detecting unit to regulate the temperature and humidity of the air supplied by said air regulating unit.

20. The health-care device as claimed in claim 11, further comprising a temperature and humidity regulating unit which is operative to regulate the temperature and humidity of the air supplied by said air regulating unit.
